(19) United States
(12) Patent Application Publication
(10) Pub. No.: US 2010/0177344 A1
(43) Pub. Date: Jul. 15, 2010

(54) IMAGE PROCESSING APPARATUS AND METHOD

(75) Inventor: Tetsuya Matsumoto, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/683,204

(22) Filed: Jan. 6, 2010

(30) Foreign Application Priority Data
Jan. 9, 2009 (JP) 2009-003626

(51) Int. Cl. G06F 15/00

(52) U.S. Cl. 358/1.15

(57) ABSTRACT

A management apparatus collects an operation log and a job log from an image forming apparatus by using a job log collection unit and an operation log collection unit. The management apparatus identifies operation log information corresponding to a start operation, of the collected operation logs, as an operation start log information while identifying an operation log corresponding to an end operation as operation end log information. The management apparatus further associates the identified operation start log information and the job log information whose job type of the collected job log matches the job type of the operation end log information, with the operation start log information and the operation end log information.

### BACKGROUND OF THE INVENTION

1. Field of the Invention

The present invention relates to an apparatus configured to manage a job log and an operation log collected from an image forming apparatus.

2. Description of the Related Art

A conventional method analyzes the status of output from an image forming apparatus based on a history of job executing (log information about a job) processed on an image forming apparatus, such as a printer or a copying machine. Generally, a result of analyzing the status of output from an image forming apparatus is utilized in improving the efficiency of business operations. In order to increase the accuracy of the analysis for improving the efficiency of business operations, it is necessary not only to analyze the status of output from an image forming apparatus but also to analyze the status of an operations executed on the image forming apparatus.

Japanese Patent Application Laid-Open No. 06-251218 discusses a method for measuring the length of time taken for executing a copy operation instructed by a user by detecting timings of start and end of the copy operation utilizing an operation detection unit.

Japanese Patent Application Laid-Open No. 2003-048362 discusses the following method. In this conventional method, a recording unit of an image forming apparatus stores information about operations executed by a customer engineer (CE: technician) of a service company during a time period from his logging in to the image forming apparatus to logging out therefrom as operation information. Furthermore, in this conventional method, the image forming apparatus registers the operation information in a central management server, which centrally manages the operation information.

To execute analysis of the status of operation of an image forming apparatus based on the history of operation (log information about an operation) of the image forming apparatus, it is necessary to identify logs of operations executed for one processing as series of operations therefor. In addition, it is necessary to acquire and use various information, such as information about to what type of processing an operation corresponds (information about a job input by the operation) and time taken for the operation (operation time).

However, in a management apparatus, which manages log information, operation log information collected (acquired) from an image forming apparatus only includes each operation log such as the date and time of operation and the content of operation. Therefore, in the above-described conventional method, only limited information can be used for an analysis of the operation status of an image forming apparatus.

In addition, if an image forming apparatus is processing a job B when a user executes an operation for inputting a job A, the image forming apparatus starts processing of the job A after processing of the job B is completed. In this case, if an operation for inputting (starting) the job A is managed as an operation for processing the job A, the above-described conventional methods may manage the time taken for processing the job B as processing time for the job A. Therefore, the above-described conventional method may not acquire a correct length of time taken for inputting and processing a job.

Further, it is useful, if a user has input a job to be processed by a plurality of image forming apparatuses operating in cooperation with one another, to analyze a job and the status of operations executed on each apparatus for the job.

In addition, it is also useful, in managing user operations, the processing time, and the like of jobs input on an image forming apparatus, if job log information and operation log information is mutually associated and thus can be traced based on the mutual association.

### SUMMARY OF THE INVENTION

The present invention is directed to a method for flexibly associating and managing operation information and job processing information on an image forming apparatus.

According to an aspect of the present invention, a management apparatus configured to collect operation log information and job log information from an image forming apparatus includes an identification unit configured to identify a plurality of operation logs corresponding to a series of operations executed on a job requested by a user and included in the operation log information collected from the image forming apparatus and an association unit configured to associate a job log corresponding to the job requested by the user and included in the job log information collected from the image forming apparatus with the plurality of operation logs identified by the identification unit, in which the operation log included in the operation log information includes information about an operation time when the operation is performed, and in which the job log included in the job log information includes information about processing time of the job. In the management apparatus, the identification unit is configured to identify a start operation log corresponding to an operation for starting the series of operations, and the association unit is configured to associate the job log whose processing time is earlier than an operation time of the start operation log with the plurality of operation logs identified by the identification unit, according to a content of the series of operations.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the present invention.

FIG. 1 illustrates an example of an image forming system including an image forming apparatus and a management apparatus according to an exemplary embodiment of the present invention.

FIG. 2 is a block diagram illustrating an exemplary hardware configuration of an information processing apparatus included in a host computer and a log collection server illustrated in FIG. 1.

FIG. 3A is a block diagram illustrating an exemplary inner configuration of a multifunction peripheral (MFP) illustrated in FIG. 1.

FIG. 3B illustrates an example of a panel (user interface (UI)) displayed on an operation panel illustrated in FIG. 3A.

FIG. 4 is a block diagram illustrating an exemplary software configuration of the host computer illustrated in FIG. 1.

FIG. 5 is a block diagram illustrating an exemplary configuration of the log collection server illustrated in FIG. 1.

FIG. 6 is a block diagram illustrating an exemplary data processing configuration of the MFP illustrated in FIG. 1.

FIG. 7 illustrates an example of an operation log information table stored in an operation log management unit illustrated in FIG. 6.

FIG. 8 illustrates an example of a job log information table stored in a job log management unit illustrated in FIG. 6.

FIG. 9 illustrates an example of an operation start/end information table stored in a log association processing unit illustrated in FIG. 5.

FIG. 10 illustrates an example of an operation log association information table managed by the log association processing unit illustrated in FIG. 5.

FIG. 11 is a timing chart illustrating an example of log association processing executed by the log association processing unit of the log collection server illustrated in FIG. 1.

FIG. 12 is a timing chart illustrating an example of log association processing executed by the log association processing unit of the log collection server illustrated in FIG. 1.

FIG. 13 is a timing chart illustrating an example of log association processing executed by the log association processing unit of the log collection server illustrated in FIG. 1.

FIG. 14 is a timing chart illustrating an example of log association processing executed by the log association processing unit of the log collection server illustrated in FIG. 1.

FIG. 15 is a timing chart illustrating an example of log association processing executed by the log association processing unit of the log collection server illustrated in FIG. 1.

FIG. 16 is a flow chart illustrating an example of first data processing executed by the management apparatus according to an exemplary embodiment of the present invention.

FIG. 17 is a flow chart illustrating an example of second data processing executed by the management apparatus according to an exemplary embodiment of the present invention.

### DESCRIPTION OF THE EMBODIMENTS

Various exemplary embodiments, features, and aspects of the invention will be described in detail below with reference to the drawings.

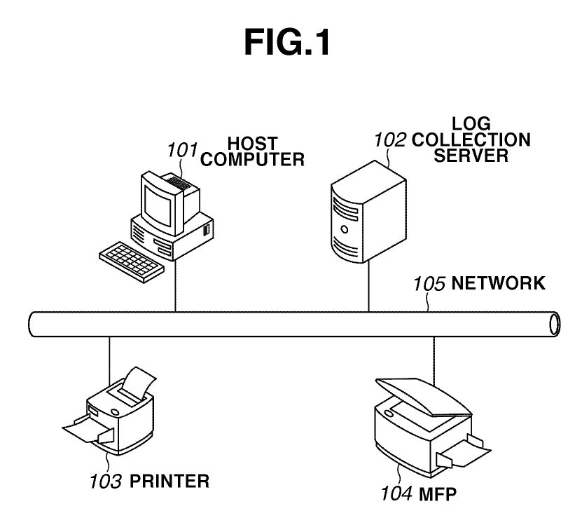

FIG. 1 illustrates an example of an image forming system including an image forming apparatus and a management apparatus according to an exemplary embodiment of the present invention. In the image forming system according to the present exemplary embodiment, the management apparatus collects and manages logs of operations executed on an image forming apparatus, which is connected to the management apparatus via a network.

Referring to FIG. 1, a host computer 101 includes a function for generating a print job to be output by a printer driver to the image forming apparatus according to a print request from an application installed thereon. In the present exemplary embodiment, the image forming apparatus includes a single function peripheral (SFP), such as a printer 103, and an MFP 104, which is connected to a network 105.

In the present exemplary embodiment, an “MFP” includes various functional units, such as a scanner unit, a printer unit, and a communication processing unit and thus is capable of executing various types of jobs such as a copy job, a print job, and a scan job. In addition, the host computer 101 executes various communication processing by using a web server function of the log collection server 102.

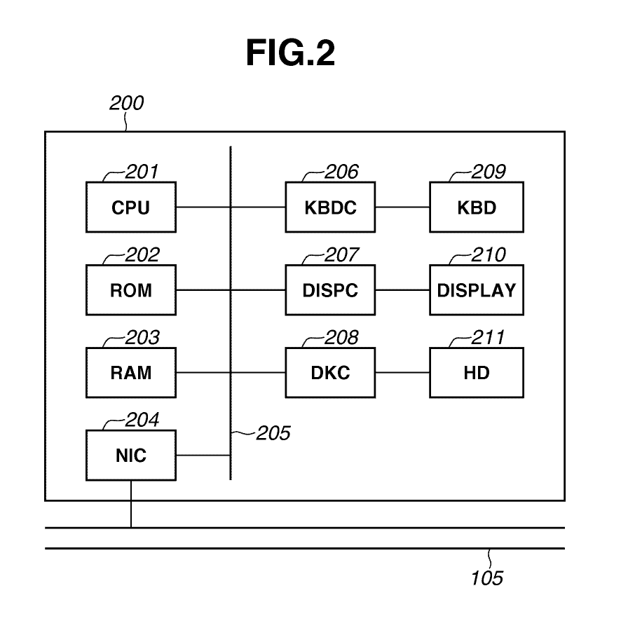

The host computer 101 includes hardware and software resources illustrated in FIG. 2, which implement data processing requested by a user by executing an application. The software resources include an operating system (OS) and a printer driver.

Furthermore, the host computer 101 can communicate with devices connected to the network 105 by a predetermined protocol, such as hypertext transport protocol (HTTP) or Simple Object Access Protocol (SOAP).

The printer 103 executes actual printing on a printing paper sheet based on print data received via the network 105 by utilizing a publicly known printing method, such as the electrophotographic printing method or the inkjet printing method.

The multifunction peripheral 104 executes actual printing on a printing paper sheet based on print data received via the network 105 by utilizing a publicly known printing method, such as the electrophotographic printing method or the inkjet printing method.

In addition, the multifunction peripheral 104 includes a function for reading an image of an original document by using the scanner unit, executing a copy job, converting the read original image into image data, and transmitting the converted image data via e-mail. The printer 103, which does not include a copy function, may be connected to the image forming system as an image forming apparatus.

The log collection server 102, which functions as the management apparatus, collects and manages job logs and operation logs of the printer 103 and the multifunction peripheral 104.

In the present exemplary embodiment, management of job logs and operation logs includes processing for mutually associating operation logs or for associating an operation log and a job log. Accordingly, the log collection server 102 includes a storage device configured to store and manage logs, such as an external storage device. A hard disk can be used as the external storage device.

The host computer 101, the MFP 104, the printer 103, and the log collection server 102 are in communication with one another via the network 105, which is implemented by a publicly known network connection method such as Ethernet.

In the present exemplary embodiment, the log collection server 102 is provided separately from the printer 103 and the MFP 104. However, the present exemplary embodiment is not limited to this. More specifically, it is also useful if modules having functions similar to those of the log collection server 102, which will be described in detail below, are provided inside the printer 103 or the MFP 104. In this case, data communication via a system bus is a substitute for the network communication among the log collection server 102, the printer 103, and the MFP 104.

FIG. 2 is a block diagram illustrating an exemplary hardware configuration of an information processing apparatus included in the host computer 101 and the log collection server 102 illustrated in FIG. 1.

Referring to FIG. 2, an information processing apparatus (personal computer (PC)) 200 includes a central processing unit (CPU) 201. The CPU 201 executes a software program stored on a mass storage device, such as a read-only memory (ROM) 202 or a hard disk (HD) 211. Furthermore, the CPU 201 has control over each device connected to a system bus 205.

A random access memory (RAM) 203 functions as a main memory and a work area for the CPU 201. A network interface card (NIC) 204 is an interface for interactive data communication with other nodes via the network 105. A keyboard controller (KBDC) 206 controls an input of a user instruction from a keyboard (KBD) 209 of the PC.

A display controller (DISPC) 207 controls a display on a display module (DISPLAY) 210. The display module 210 includes a liquid crystal display (LCD). A disk controller (DKC) 208 controls the hard disk (HD) 211, which is a mass storage device.

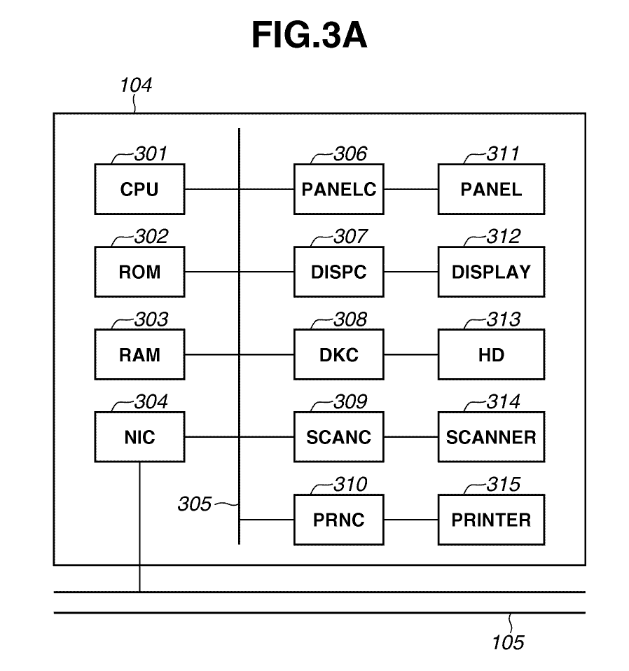

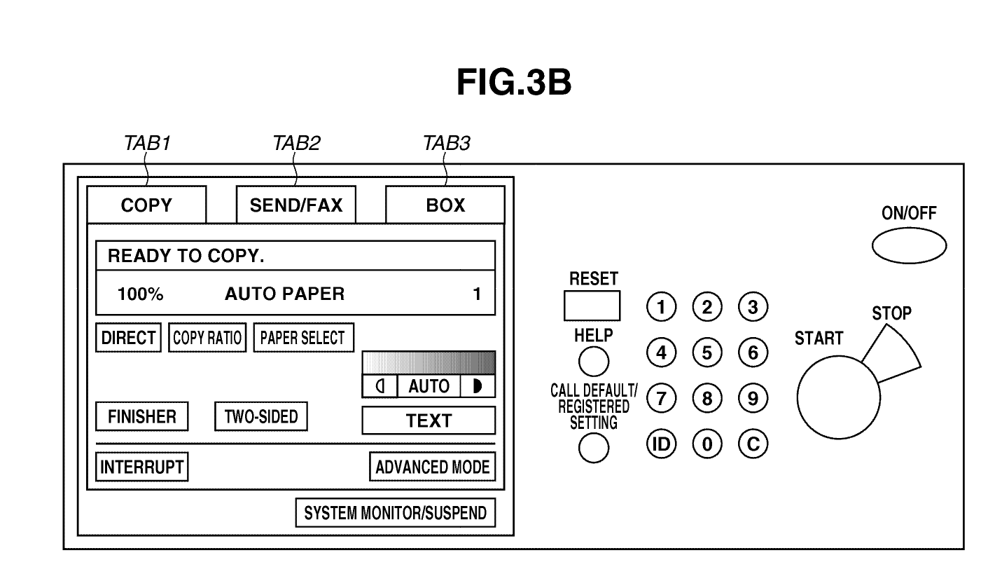

FIG. 3A is a block diagram illustrating an exemplary inner configuration of the MFP 104 illustrated in FIG. 1.

Referring to FIG. 3A, the MFP 104 includes a CPU 301. The CPU 301 executes a software program stored on a ROM 302 or an HD (mass storage device) 313. Furthermore, The CPU 301 executes a software program stored on the HD 313 and performs control over each device connected to a system bus 305.

A RAM 303 functions as a main memory and a work area for the CPU 301. An NIC 304 is an interface for interactive data communication with other nodes via the network 105.

More specifically, the NIC 304 receives a print job from the host computer 101 or a cooperative job from the image forming apparatus (another MFP). In the present exemplary embodiment, in a “cooperative job”, an image acquired by scanning in one apparatus is printed on another apparatus (a “remote copy job”), transmitted by facsimile (a “remote FAX job”), or transmitted via e-mail as an attached file (a “remote send job”).

In the cooperative job for transmitting image data to an external apparatus, it is useful if a cooperative apparatus, a transmission method, and a transmission target apparatus are set on the apparatus that has executed the scanning of the read image data or if a transmission method and a transmission target apparatus are set on the apparatus that executes external transmission. In the present exemplary embodiment, the MFP 104 and an external apparatus are connected via a network. However, the present exemplary embodiment is not limited to this. More specifically, another exemplary method, which can also implement data communication and will be described in detail later below, can be implemented as another aspect of the present invention.

A panel controller (PANELC) 306 controls an input of a user instruction from an operation panel (PANEL) 311 of the MFP 104.

FIG. 3B illustrates an example of a UI panel displayed on the operation panel (PANEL) 311 illustrated in FIG. 3A. In the present exemplary embodiment, the user can input an instruction to the image forming apparatus via the panel UI.

Referring to FIG. 3B, the user can input an instruction for starting a copy job after setting the number of prints via the panel UI. In addition, the user can execute an operation for reading and printing data stored in a predetermined storage area (a “box”) of the MFP 104. When the user selects any of tab keys (TABs) 1 through 3, each of which corresponding to either one of the above-described operation, the CPU 301 executes a function corresponding to the user operation.

A display controller (DISPC) 307 controls a display on a display module (DISPLAY) 312.

The display module 312 includes an LCD. A disk controller (DKC) 308 controls the hard disk (HD) 313, which is a mass storage device. A scanner controller (SCANC) 309 controls an optical scanner device (scanner) 314 of the MFP 104 to control scanning of an original document.

A printer controller (PRNC) 310 controls a printer apparatus (printer) 315 of the MFP 104. The printer controller 310 executes actual printing on a printing paper sheet by utilizing a publicly known printing method, such as the electrophotographic printing method or the inkjet printing method.

The inner configuration of the printer 103 is similar to the inner configuration of the MFP 104 except that the printer 103 does not include the scanner controller 309 or the optical scanner 314.

However, the present exemplary embodiment is not limited to this. More specifically, it is also useful if the printer 103 does not include a panel controller 306, an operation panel 311, a display controller 307, or a display module 312.

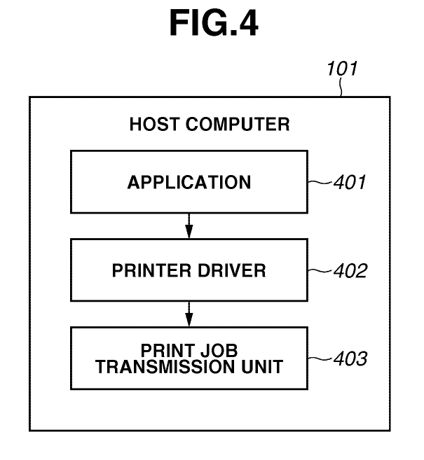

FIG. 4 is a block diagram illustrating an exemplary software configuration of the host computer 101 illustrated in FIG. 1.

Referring to FIG. 4, an application 401 is an application for instructing printing. More specifically, the application 401 gives an instruction for printing by transmitting a drawing command to a printer driver 402. The printer driver 402 converts the drawing command received from the application 401 into print data that the MFP 104 can interpret (i.e., into page description language (PDL)).

In addition, the printer driver 402 adds, to the print data, an identification (ID) of the user who has operated the application 401 to instruct the printing as job owner information. Furthermore, the printer driver 402 transmits a print job generated in the above-described manner to a print job transmission unit 403. The print job transmission unit 403 transmits the print job, which has been received from the printer driver 402 as described above, to the MFP 104 via the network 105.

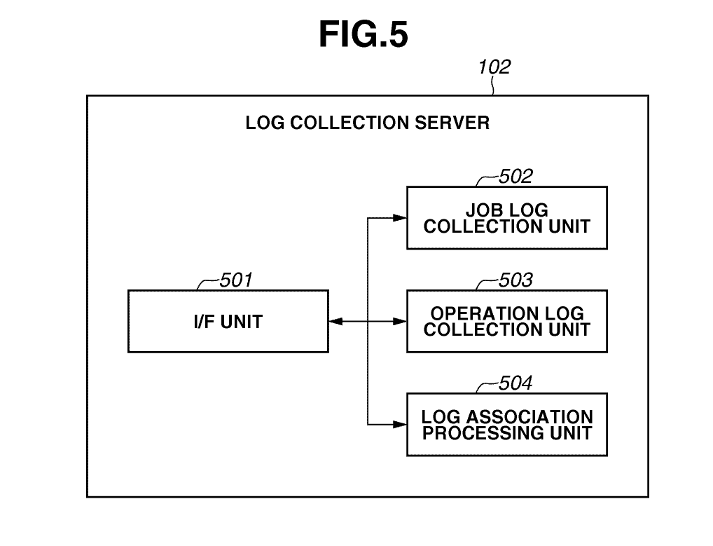

FIG. 5 is a block diagram illustrating an exemplary configuration of the log collection server 102 illustrated in FIG. 1.

Referring to FIG. 5, an interface unit 501 executes data communication with the MFP 104 via the network 105 and via the NIC 204 illustrated in FIG. 2. A job log collection unit 502 collects job log information from the printer 103 and the MFP 104. Furthermore, the job log collection unit 502 stores the job log information in a job information area provided on the HD 211.

The operation log collection unit 503 collects operation log information from the printer 103 and the MFP 104. Furthermore, the operation log collection unit 503 stores the operation log information in an operation information area provided on the HD 211

A log association processing unit 504 associates the operation logs collected by the operation log collection unit 503 one another. In addition, the log association processing unit 504 mutually associates the job log and the operation log collected by the job log collection unit 502 and the operation log collection unit 503. In the present exemplary embodiment, the information associated by the log association processing unit 504 is stored in the storage area of the HD 211.

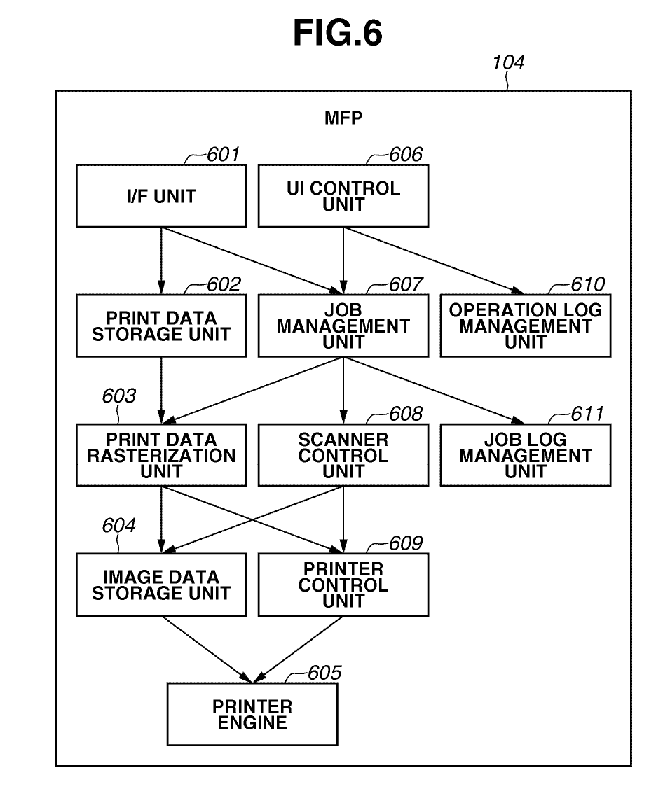

FIG. 6 is a block diagram illustrating an exemplary data processing configuration of the MFP 104 illustrated in FIG. 1.

Referring to FIG. 6, an interface unit 601 is connected to the network 105 via the NIC 304. The interface unit 601 is an interface for transmitting and receiving data to and from an external apparatus. More specifically, the MFP 104 receives a print job from the host computer 101. A print data storage unit 602 temporarily stores data of a print job.

A UI control unit 606 controls the panel UI of the operation panel 311 via the panel controller (PANELC) 306 to receive a copy instruction or a scan and transmit instruction from the user to the MFP 104.

A job management unit 607 analyzes the print job received from the host computer 101 and collects output attribute information, such as the number of prints or the printing color mode. Furthermore, the job management unit 607 manages the collected attribute information simultaneously with the start of the job.

A print data rasterization unit 603 collects print data from the print data storage unit 602 according to job information managed by the job management unit 607 and executes image generation processing to generates image data on the RAM 303.

A scanner control unit 608 controls the scanner controller 309 to scan an original document and generate image data based on the read image of the original document. If an auto document feeder (ADF) or a recirculating document feeder (RDF) is connected to the scanner 314 as a document feeding unit, the scanner control unit 608 also controls feeding and discharging of an original document from the ADF or the RDF. Furthermore, if an image of a two-sided document is read, the scanner control unit 608 controls the reversal of the document.

An image data storage unit 604 temporarily stores the image data generated by the print data rasterization unit 603 and the scanner control unit 608. A printer control unit 609 controls a printer engine 605 to print the image data stored in the image data storage unit 604.

The printer engine 605 executes actual printing of the image data stored in the image data storage unit 604, on a printing medium, such as a printing paper by utilizing a publicly known printing method, such as the electrophotographic printing method or the inkjet printing method.

An operation log management unit 610 manages operation log information. When the user executes an operation (inputs an instruction) via the panel UI, the UI control unit 606 transmits information about the user operation to the operation log management unit 610. The operation log management unit 610 stores the received operation information. Furthermore, based on a request from the log collection server 102, the operation log management unit 610 reads and transmits the operation log managed thereby.

A job log management unit 611 manages job log information. When a job is completely processed, the job management unit 607 transmits job information to be managed to the job log management unit 611 as job log information. The job log management unit 611 stores the received job log information. Furthermore, the job log management unit 611 transmits the job log managed thereby according to a request from the log collection server 102.

The printer 103, which includes no scanner, has a configuration similar to the above-described configuration of the MFP 104 except that the printer 103 does not include a scanner control unit 608, a UI control unit 606, or an operation log management unit 610.

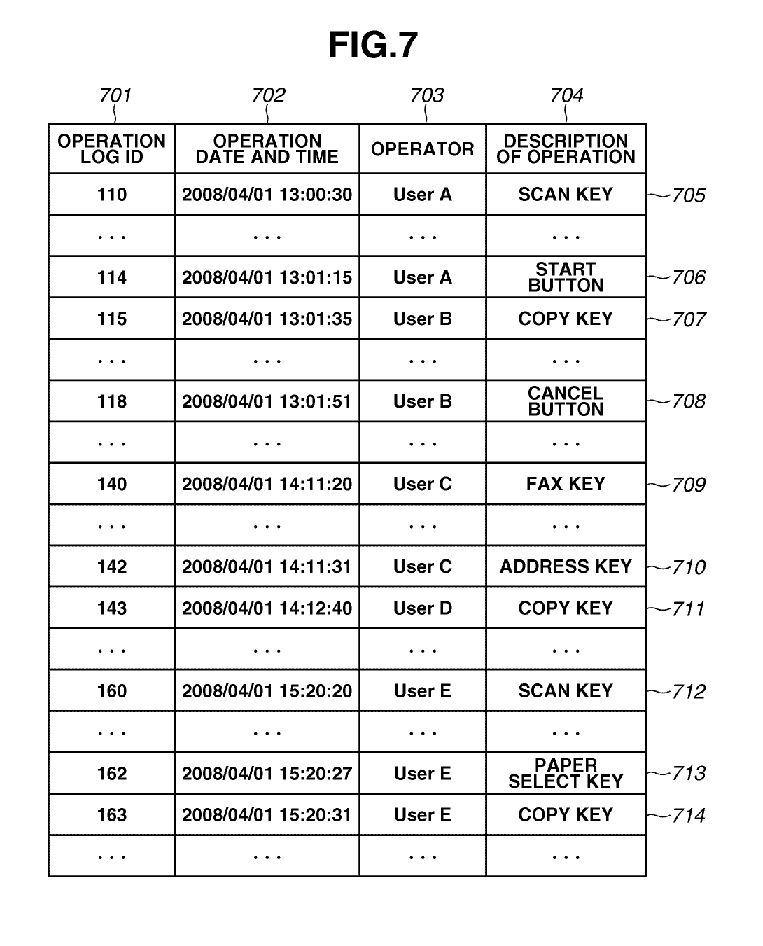

FIG. 7 illustrates an example of an operation log information table stored by the operation log management unit 610 illustrated in FIG. 6. The operation log information stored in the operation log information table illustrated in FIG. 7 is information about logs of operations executed by the user on the MFP 104 (FIG. 1).

In the present exemplary embodiment, operation log information includes information about the time taken to execute an operation, such as operation start date and time and operation end date and time. By using the operation log information, a start operation log and an end operation log can be identified. In addition, the operation log information table manages the operation logs in chronological order.

Referring to FIG. 7, an operation log ID 701 is an ID for uniquely identifying an operation log of the MFP 104 within the image forming system. A field 702 stores the date and time of execution of an operation.

An operator field 703 stores information about the user who has executed the operation (the operator). More specifically, the operator field 703 stores a user name and a user ID corresponding to user information. A “description of operation” field 704 stores a content of the operation (which key or button the user has operated), such as “copy key”, “scan key”, “start button”, “cancel button”, “paper select key”, or “transmission destination key”.

Furthermore, the operation log information table includes records 705 through 714 for operation logs. More specifically, the record 705 is a record of an operation log including a parameter value “110” for the operation log ID 701, “user A” for the operator 703, “scan key” for the “description of operation” field 704, and “2008/04/01 13:00:30” for the operation time 702.

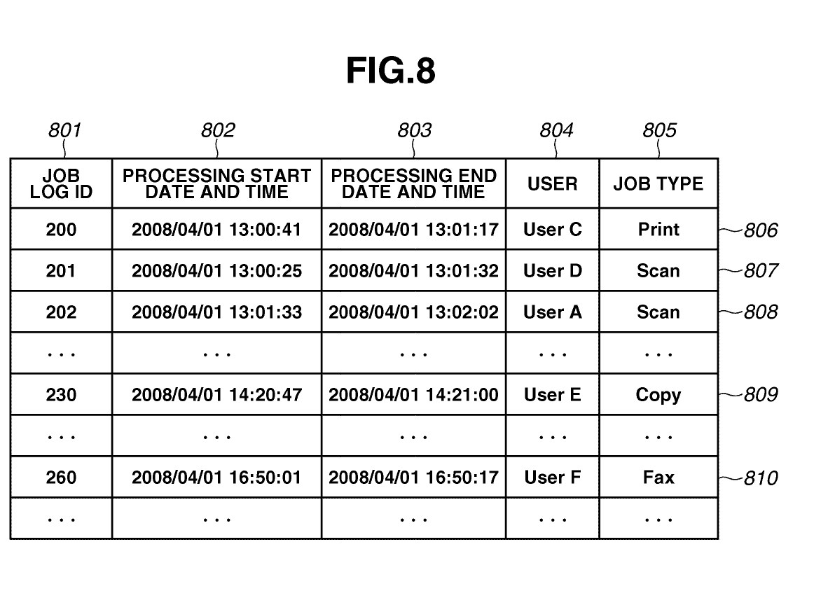

FIG. 8 illustrates an example of a job log information table stored by the job log management unit 611 illustrated in FIG. 6. The job log information table manages records 806 through 810.

Referring to FIG. 8, a job log ID field 801 stores an ID for uniquely identifying a job log within the image forming system. A field 802 stores a start date and time of processing of a corresponding job. A field 803 stores an end date and time of processing of the job. A field 804 stores information about a user who has input the job. The field 804 stores a user name and a user ID of the user. A field 805 stores a job type.

In the present exemplary embodiment, the job type includes a print job, which is a job for printing from the host computer 101, a copy job, and a scan job. The present exemplary embodiment can calculate the time taken for one job based on the processing start date and time 802 and the processing end date and time 803.

It is useful, for cooperative processing, which is executed by using a plurality of apparatuses, to register the name of the cooperative processing and the type of actual processing (e.g., “scan (remote copy)”) as the job type. Accordingly, jobs can be mutually associated for cooperative processing. Furthermore, a user operation for cooperative processing can be analyzed during association of a job log with an operation log. The association of a job log with an operation log will be described in detail below.

A method for associating job logs included in one cooperative processing is not limited to the above-mentioned. In the present invention, the log collection server 102 collects logs of a plurality of apparatuses and mutually associates the collected logs. Thus, the present invention can associate operation logs and job logs in cooperative processing.

For example, the record 806 is a record of a job log of a print job having a parameter “user C” for the user 804, “2008/04/01 13:00:41” for the processing start date and time 802, and “2008/04/01 13:01:17” for the processing end date and time 803. It is also useful if the job log information table is generated for each job type.

In the present exemplary embodiment, the log information illustrated in FIGS. 7 and 8 indicates information about the operation executed by the user and the job requested by the user from the MFP 104. In managing the log information in a table, it is also useful if logs collected from a plurality of image forming apparatuses are centrally managed.

In this case, a field that stores information for identifying an image forming apparatus is added to each of the tables illustrated in FIGS. 7 and 8. Furthermore, in this case, it is useful if an image forming apparatus ID is input on the server after collecting log information. In addition, it is also useful if image forming apparatus ID information is included in a log itself as a management item.

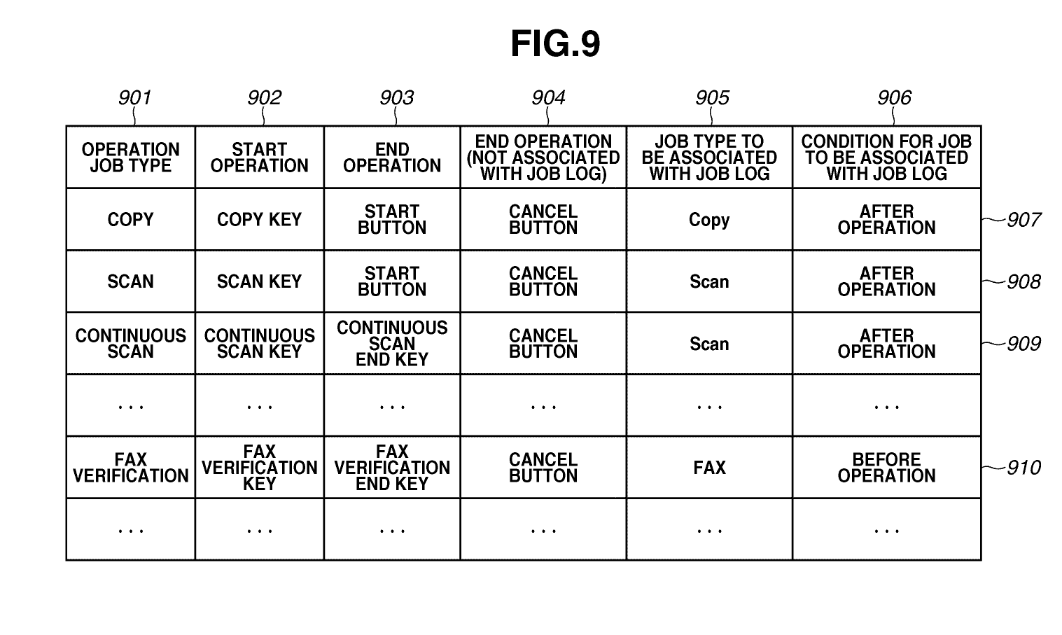

FIG. 9 illustrates an example of an operation start/end information table stored by the log association processing unit 504 illustrated in FIG. 5. The operation start/end information table illustrated in FIG. 9 is stored in a predetermined storage area of the log collection server 102.

In addition, the operation start/end information table illustrated in FIG. 9 stores various information, such as a start operation, an end operation, and a job log to be associated with, which may vary according to an job operation type. The information about the start operation and end operation is previously set and managed by the log association processing unit 504 (FIG. 5).

It is also useful if an administrator of the system arbitrarily generates or adds start/end operation information. In this case, the administrator can generate or add start/end operation information according to information about the status of operation of keys and buttons of the image forming apparatus.

Referring to FIG. 9, a job operation type 901 stores a job type, which is acquired by classifying the job type 805 (FIG. 8) at the same or more detailed classification level according to the difference between the starting operations. The job operation type 901 includes parameter values such as “copy”, “scan”, “continuous scan”, and “FAX verification”.

A start operation field 902 stores a content of a start operation. The start operation 902 includes parameter values such as “copy key”, “scan key”, and the like. An end operation field 903 stores a content of an end operation. The end operation 903 includes parameter values such as “start button”, “continuous scan end key”, and the like. An end operation (not associated with job log) field 904 stores a content of an end operation not to be associated with a job log. In the present exemplary embodiment, an “end operation not to be associated with a job log” includes information indicating that an operation for suspending an already input operation is executed by pressing the cancel button or the like when no job has been input.

A “job type to be associated with job log” field 905 stores information indicating with which job type of a job log the corresponding operation is to be associated.

A field 906 stores information indicating a condition for a job to be associated with a job log. In the example illustrated in FIG. 9, the timing for processing a job to be associated with a job log is set as the condition. The field 906 stores parameter values such as “after operation”, “before operation”, or “during operation”.

More specifically, in the present exemplary embodiment, if the job operation type is “copy” (record 907), logs of an operation of the copy key, which is a start operation, and an operation of the start key, which is an end operation, are associated with a job log of any copy job input after the operation.

Furthermore, if the job operation type is “scan” (record 908), logs of an operation of the scan key, which is a start operation, and an operation of the start key, which is an end operation, are associated with a job log of any scan job input after the operation.

Moreover, if the job operation type is “continuous scan” (record 909), logs of an operation of the continuous scan key, which is a start operation, and an operation of the continuous scan end key, which is an end operation, are associated with a job log of any scan job input after the operation. The records 908 and 909 are start/end operation information of an operation whose job type is “scan”. The records 908 and 909 are managed as different job operation type because the start operations thereof differ from each other.

In addition, if the job operation type is “FAX verification” (record 910), logs of an operation of the FAX verification key, which is a start operation, and an operation of the FAX verification end key, which is an end operation, are associated with a job log of any FAX transmission job input before the operation.

In a verification operation as in the record 910, the user has input a job before the operation. Accordingly, the operation in this case is associated with a job log of the job that has been input before the verification operation by the user. In the present exemplary embodiment, the operation by the FAX verification key corresponds to a job selection operation by the user in job verification processing.

If the start/end operations differ according to the model type of the image forming apparatus, the present exemplary embodiment generates a start/end operation information table for each model type of image forming apparatus.

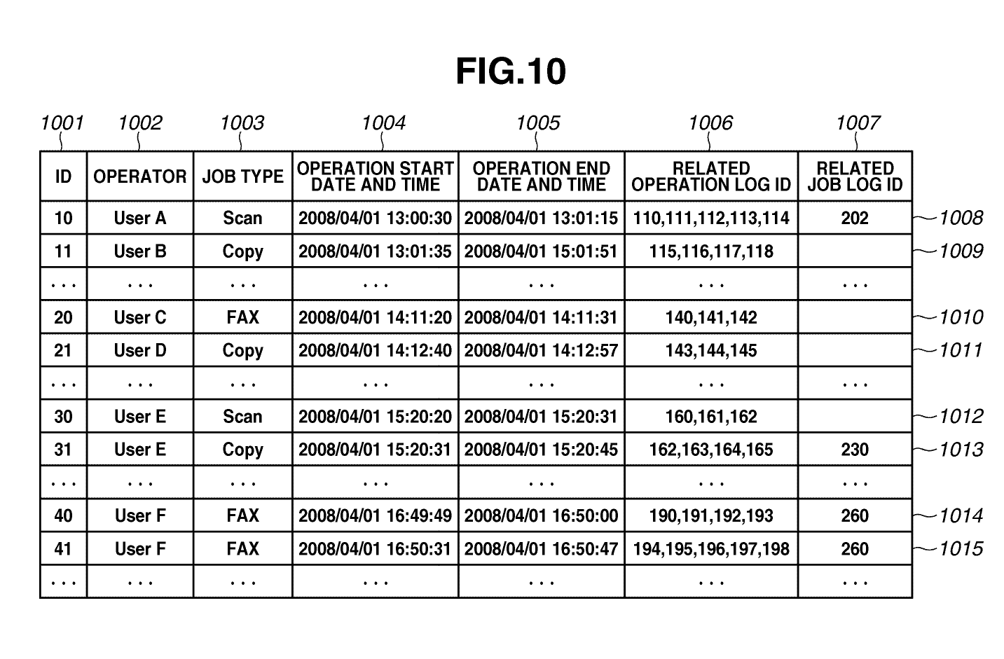

FIG. 10 illustrates an example of an operation log association information table managed by the log association processing unit 504 illustrated in FIG. 5. In the example illustrated in FIG. 10, the operation log association information table manages various information such as the operator of the series of operations, the operation start date and time, the operation end date and time, a related operation log, and a related job log.

Referring to FIG. 10, an association information ID 1001 is an ID for uniquely identifying operation log association information within the image forming system. An operator field 1002 stores information about an operator of the series of operations. A field 1003 stores a job type, which is information about for which job type 805 the series of operations have been executed.

A field 1004 stores the start date and time of the series of operations. A field 1005 stores the end date and time of the series of operations. A field 1006 stores an operation log ID 701 related to the series of operations. More specifically, the related operation log ID 1006 is an operation log ID of an operation executed during the series of operations.

A related job ID field 1007 stores a job log ID 801 related to the series of operations. In the present exemplary embodiment, a “related job log ID” is a job log ID of a job input by the series of operations or a job verified as having been normally input. In the example illustrated in FIG. 10, the table includes records 1008 through 1015.

More specifically, the record 1008 is operation log association information about an operation, which is executed by the operator “user A” for a scan job, starting at the date and time “2008/04/01 13:00:30” and ending at the date and time “2008/04/01 13:01:15”. Operation log IDs of the operations executed in the series of operations corresponding to the record 1008 include IDs “110”, “111”, “112”, “113”, and “114”. The log ID of the related job input by the operation corresponding to the record 1008 is ID “202”.

It is also useful if the association information ID 1001 (FIG. 10) is stored as information for mutually associating the mutually related operation logs included in the operation log ID managed by the operation log collection unit 503 (FIG. 5).

It is also useful if the job log information table managed by the job log collection unit 502 (FIG. 5) stores a related operation log association information ID 1001. Furthermore, it is also useful if an operation log association information table is generated for each job type.

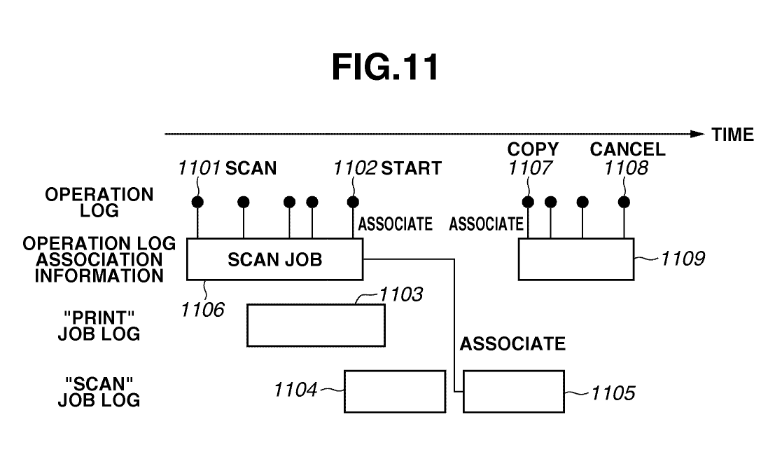

FIG. 11 is a timing chart illustrating an example of log association processing executed by the log association processing unit 504 of the log collection server 102 illustrated in FIG. 1.

Referring to FIG. 11, timing is taken on the horizontal axis. In the example illustrated in FIG. 11, the time flows rightwards on the horizontal axis.

An operation log 1101 corresponds to the record 705 stored in the operation log information table illustrated in FIG. 7. The operation log 1101 corresponds to an operation of the scan key by the user A. An operation log 1102 corresponds to the record (operation log information) 706 stored in the operation log information table illustrated in FIG. 7. The operation log 1102 corresponds to an operation of the start button by the user A.

A job log 1103 corresponds to the record 806 stored in the job log information table illustrated in FIG. 8. The job log 1103 corresponds to a job log of the print job input by the user C. A job log 1104 corresponds to the record 807 stored in the job log information table illustrated in FIG. 8. The job log 1104 corresponds to a job log of the scan job input by a user D.

A job log 1105 corresponds to the record 808 stored in the job log information table illustrated in FIG. 8. The job log 1105 corresponds to a job log of the scan job input by the user A performing the operations executed during the time period from the timing of the operation logs 1101 to the timing of the operation log 1102 and 1102.

Operation log association information 1106 corresponds to the record 1008 stored in the operation log association information table illustrated in FIG. 10. The operation log association information 1106 is output by the log association processing unit 504 based on the information included in the record 908 stored in the operation start/end information table illustrated in FIG. 9. In the present exemplary embodiment, the log association processing unit 504 determines that the content of the operation of the operation log 1101 is the start operation and that the content of the operation of the operation log 1102 is the end operation.

In addition, the log association processing unit 504, sets the operation time of the operation log 1101 as the operation start date and time of the operation log association information 1106. Furthermore, the log association processing unit 504 sets the operation time of the operation log 1102 as the operation end date and time of the operation log association information 1106.

In addition, the log association processing unit 504 refers to the record 908 and sets the job type to be associated with job log of the record 908 as the job type of the operation log association information 1106.

In addition, the log association processing unit 504 sets the operator of the operations executed during the time period from the timing of the operation logs 1101 to the timing of the operation log 1102 and 1102 (i.e., the user A) as the operator of the operation corresponding to the operation log association information 1106.

Furthermore, the log association processing unit 504 sets the operation log ID stored in the operation log of the operations executed during the time period from the timing of the operation log 1101 to the timing of the operation log 1102 as the related operation log ID of the operation log association information 1106. Thus, the log association processing unit 504 mutually associates the operation logs. In addition, the log association processing unit 504 searches for a job log of a job input after the operation executed by the user A and whose job type is “scan”.

Then, the log association processing unit 504 determines that the job log 1105 is a job log of the job input by the operations executed during the time period from the timing of the operation log 1101 to the timing of the operation log 1102. In addition, the log association processing unit 504 sets the job log ID of the job log 1105 as the related job log ID of the operation log association information 1106. Thus, the log association processing unit 504 associates the job log whose job log ID is “202” with the operation log.

In the example illustrated in FIG. 11, an operation log 1107 corresponds to the record 707 stored in the operation log information table illustrated in FIG. 7. The operation log 1107 corresponds to an operation of the copy key by the user B.

An operation log 1108 corresponds to the record 708 stored in the operation log information table illustrated in FIG. 7. The operation log 1107 corresponds to an operation of the cancel button by the user B.

Operation log association information 1109 corresponds to the record 1009 stored in the operation log association information table illustrated in FIG. 10. The operation log association information 1109 is output by the log association processing unit 504 based on the information included in the record 907 stored in the operation start/end information table illustrated in FIG. 9.

In the example illustrated in FIG. 11, the content of the operation corresponding to the operation log 1108 matches the end operation (not to be associated with the job log) for the record 907. Accordingly, the log association processing unit 504 determines that no job log is to be associated with the operation log association information 1109. Accordingly, even if a user has executed only operations without inputting a job, operation log association information 1109 is generated and stored in the operation log association information table illustrated in FIG. 10.

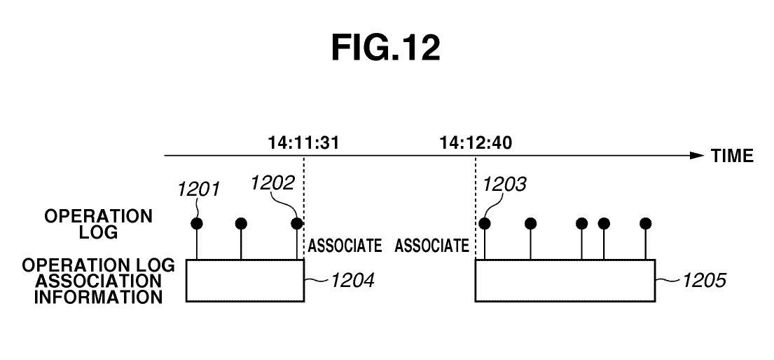

FIG. 12 is a timing chart illustrating an example of log association processing executed by the log association processing unit 504 of the log collection server 102 illustrated in FIG. 1. In FIG. 12, timing is taken on the horizontal axis and the time flows rightwards on the horizontal axis.

An operation log 1201 corresponds to the record 709 stored in the operation log information table illustrated in FIG. 7. The operation log 1201 corresponds to an operation of the FAX key by the user C. An operation log 1202 corresponds to the record 710 stored in the operation log information table illustrated in FIG. 7. The operation log 1202 corresponds to an operation of the transmission key executed by the user C at the timing “2008/04/01 14:11:31”.

An operation log 1203 corresponds to the record 711 stored in the operation log information table illustrated in FIG. 7. The operation log 1203 corresponds to an operation of the copy key executed by the user D at the timing “2008/04/01 14:12:40”.

Operation log association information 1204 corresponds to the record (operation log association information) 1010 stored in the operation log association information table illustrated in FIG. 10. Operation log association information 1205 corresponds to the record (operation log association information) 1011 stored in the operation log association information table illustrated in FIG. 10.

The log association processing unit 504 (FIG. 5) stores a predetermined time. If it is determined that the user has not executed any operation for the time period equivalent to the predetermined time, then the log association processing unit 504 determines that the image forming apparatus has not been used. In the present exemplary embodiment, the predetermined time of sixty seconds is set.

In the present exemplary embodiment, the difference between the operation time of the operation log 1202 and that of the operation log 1203 is equal to or greater than sixty seconds (the predetermined time). Accordingly, the log association processing unit 504 determines that the image forming apparatus has not been used during the time period from the timing of the operation log 1202 to the timing of the operation log 1203.

In addition, the log association processing unit 504 sets the operation time of the operation log 1202 as the operation end date and time of the operation log association information 1204. Furthermore, the log association processing unit 504 outputs the same to the operation log association information 1204.

The log association processing unit 504 does not associate any job log with the operation log association information 1204. Therefore, no information is stored in the related job log ID field 1007 in the operation log association information table illustrated in FIG. 10.

On the other hand, the log association processing unit 504 sets the operation time of the operation log 1203 as the operation start date and time of the operation log association information 1205. Furthermore, the log association processing unit 504 outputs operation log association information 1204. Accordingly, the log collection server 102 can acquire correct operation information even if the user has discontinued the operation on the image forming apparatus without executing an end operation.

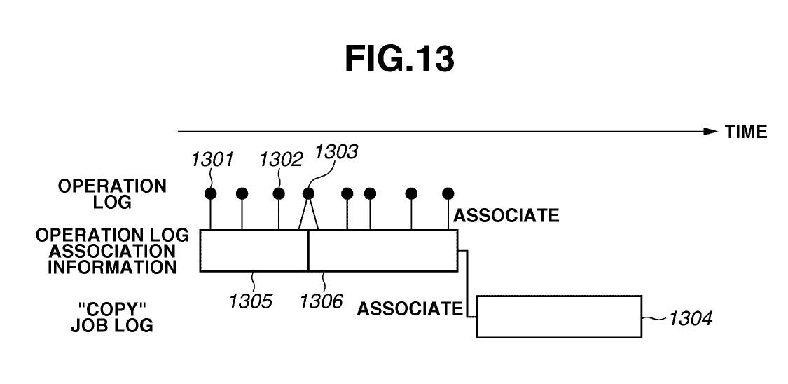

FIG. 13 is a timing chart illustrating an example of log association processing executed by the log association processing unit 504 of the log collection server 102 illustrated in FIG. 1.

Referring to FIG. 13, timing is taken on the horizontal axis. In the example illustrated in FIG. 11, the time flows rightwards on the horizontal axis.

An operation log 1301 corresponds to the record 712 stored in the operation log information table illustrated in FIG. 7. The operation log 1301 corresponds to an operation of the scan key by a user E. An operation log 1302 corresponds to the record 713 stored in the operation log information table illustrated in FIG. 7. The operation log 1302 corresponds to an operation of the paper select key by the user E.

An operation log 1303 corresponds to the record 714 stored in the operation log information table illustrated in FIG. 7. The operation log 1303 corresponds to an operation of the copy key by the user E. A job log 1304 corresponds to the record 809 stored in the job log information table illustrated in FIG. 8. The job log 1304 corresponds to a job log of the scan job input by the user E by executing the operations of the operation log 1301.

Operation log association information 1305 corresponds to the record 1012 stored in the operation log association information table illustrated in FIG. 10. Operation log association information 1306 corresponds to the record 1013 stored in the operation log association information table illustrated in FIG. 10.

In the present exemplary embodiment, the user E executed an operation for starting processing of a scan job but did not complete the scan job start operation. Then, the user E started an operation for starting processing of a copy job (i.e., the user has input a copy job).

In this case, the log association processing unit 504 determines that the operation log 1303 of the copy start operation is an operation for ending the operations before the operation of the operation log 1303 and an operation for starting the operations of the operation log 1303 and beyond.

In addition, the log association processing unit 504 sets the operation time of the operation log 1303 as the operation end date and time of the operation log association information 1305 and generates operation log association information 1305.

Furthermore, the log association processing unit 504 sets the operation time of the operation log 1303 as the operation end date and time of the operation log association information 1306 and generates operation log association information 1306.

Accordingly, the log collection server 102 can acquire correct operation information about each job type even if the user has discontinued the operation before completely executing the same but started an operation for another job type.

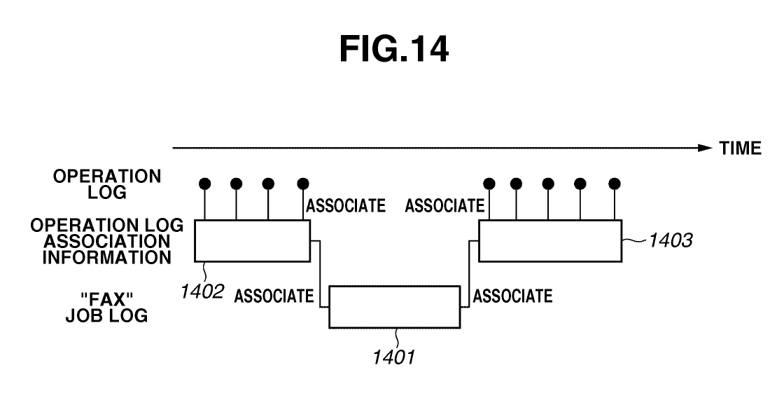

FIG. 14 is a timing chart illustrating an example of log association processing executed by the log association processing unit 504 of the log collection server 102 illustrated in FIG. 1.

Referring to FIG. 14, timing is taken on the horizontal axis. In the example illustrated in FIG. 14, the time flows rightwards on the horizontal axis.

A job log 1401 corresponds to the record 810 stored in the job log information table illustrated in FIG. 8. The job log 1401 corresponds to a job log of the FAX job input by a user F.

Operation log association information 1402 corresponds to the record 1014 stored in the operation log association information table illustrated in FIG. 10. Operation log association information 1403 corresponds to the record 1015 stored in the operation log association information table illustrated in FIG. 10.

In the present exemplary embodiment, the user F has executed an operation for starting a FAX job, input a FAX job, and executed an operation for verifying whether the FAX has been normally transmitted. In this case, the log association processing unit 504 associates not only the operation log of the operation for inputting the FAX job but also an operation log of the operation for verifying whether the FAX has been normally transmitted with the job log of the FAX job.

The record 1014 is generated by the log association processing unit 504 according to information included in the record 910 stored in the operation start/end information table illustrated in FIG. 9.

The log association processing unit 504 searches for a job log of a job input before the operation executed by the user F and whose job type is “FAX”, based on information included in the record 910.

Then, the log association processing unit 504 determines that the job log 1401 is a job log of the job verified by the operation associated with the record 1014. In addition, the log association processing unit 504 sets the job log ID of the job log 1401 “260” as the related job log ID of the record 1015. Thus, the log association processing unit 504 associates the job log with the operation log.

Accordingly, the log collection server 102 can acquire information about with which job a user operation executed after inputting a job is related.

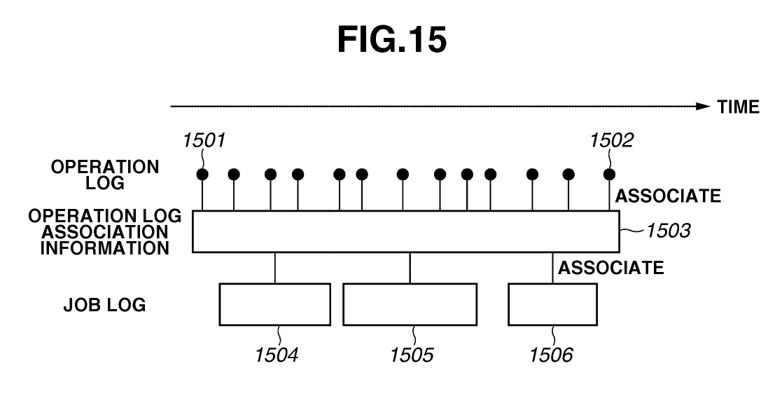

FIG. 15 is a timing chart illustrating an example of log association processing executed by the log association processing unit 504 of the log collection server 102 illustrated in FIG. 1.

Referring to FIG. 15, timing is taken on the horizontal axis. In the example illustrated in FIG. 15, the time flows rightwards on the horizontal axis.

In the example illustrated in FIG. 15, it is supposed that the system administrator or a service staff has executed the maintenance of the image forming apparatus, during which a plurality of jobs is input.

In the present exemplary embodiment, in distinguishing between the jobs input during the maintenance, an operation for starting the maintenance is set as the start operation 902 stored in the operation start/end information table illustrated in FIG. 9. Furthermore, in this case, an operation for ending the maintenance is set as the end operation 903 stored in the operation start/end information table illustrated in FIG. 9. Further, as an association job type 905, a job association execution date and time of information about all job types is set as “during operation”.

In the example illustrated in FIG. 15, an operation log 1501 corresponds to a maintenance start operation. an operation log 1502 corresponds to a maintenance end operation. Job logs 1504 through 1506 are job logs of the jobs input during the maintenance. Operation log association information 1503 is operation log association information about the operation executed for the maintenance. The operation log association information 1503 is output by the log association processing unit 504.

The log association processing unit 504 searches all the job logs collected during the maintenance according to information stored in the operation start/end information table. Furthermore, the log association processing unit 504 sets the job log ID of the job log as a related job log ID of the operation log association information 1506. Thus, the log association processing unit 504 associates the job log with the operation log.

Accordingly, the log collection server 102 can acquire information about operations executed for maintenance and jobs input during the maintenance.

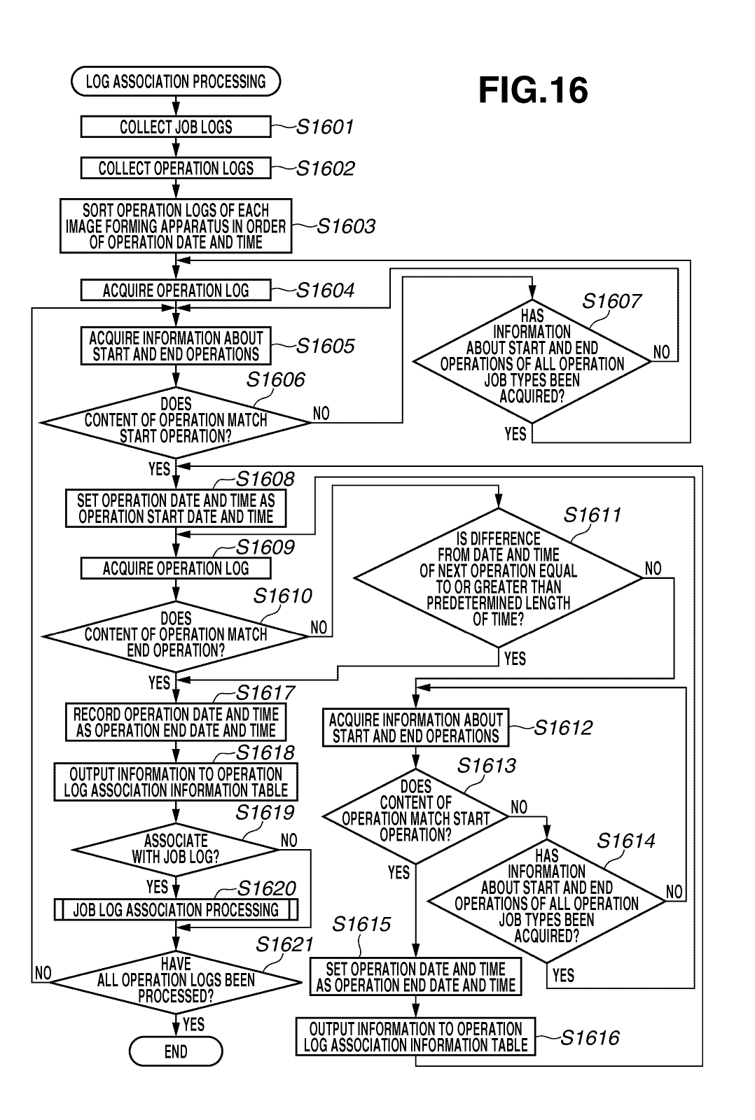

FIG. 16 is a flow chart illustrating an example of first data processing executed by the management apparatus according to an exemplary embodiment of the present invention.

In the present exemplary embodiment, the log collection server 102 (FIG. 1) functions as the management server and executes log association processing. Each step of the processing in the flow chart of FIG. 16 is implemented by the CPU 201 of the log collection server 102 by loading and executing a control program from the HD 211 or the ROM 202 on the RAM 203.

Referring to FIG. 16, when log association processing has started, in step S1601, the job log collection unit 502 of the log collection server 102 communicates with the printer 103 and the MFP 104 via the interface unit 501 to collect the job logs managed by the job log management unit 611.

In step S1602, the operation log collection unit 503 of the log collection server 102 communicates with the printer 103 and the MFP 104 via the interface unit 501 to collect the operation logs managed by the operation log management unit 610.

In the present exemplary embodiment, the collected job logs are managed by the job log collection unit 502 in a table equivalent to or expanded from the job log information table illustrated in FIG. 8. Similarly, the collected operation logs are managed by the operation log collection unit 503 in a table equivalent to or expanded from the operation log information table illustrated in FIG. 7. In collecting log information from a plurality of image forming apparatuses, it is useful to provide the table with a column for storing an ID of each image forming apparatus.

In step S1603, the log association processing unit 504 sorts the operation logs (FIG. 8) collected by the operation log collection unit 503 in ascending order of the operation time, for each image forming apparatus.

In step S1604, the log association processing unit 504 acquires the operation logs illustrated in FIG. 8, which have been acquired by the operation log collection unit 503. In step S1605, the log association processing unit 504 acquires the operation start/end information from the operation start/end information table illustrated in FIG. 9.

In step S1606, the log association processing unit 504 determines whether the content of operation of the operation log acquired in step S1604 matches the start operation 902 of the operation start/end information acquired in step S1605.

If it is determined that the content of operation of the operation log acquired in step S1604 matches the start operation 902 of the operation start/end information acquired in step S1605 (YES in step S1606), then the processing advances to step S1608.

On the other hand, if it is determined that the content of operation of the operation log acquired in step S1604 does not match the start operation 902 of the operation start/end information acquired in step S1605 (NO in step S1606), then the processing advances to step S1607. In step S1607, the log association processing unit 504 determines whether information about all the operation job types stored in the start/end operation information table has been acquired.

If it is determined that information about all the operation job types stored in the start/end operation information table has been acquired (YES in step S1607), then the processing returns to step S1604 and executes the processing in step S1604 and beyond again.

On the other hand, if it is determined that information about all the operation job types stored in the start/end operation information table has not been acquired (NO in step S1607), then the processing returns to step S1605 and executes the processing in step S1605 and beyond again.

In step S1608, the log association processing unit 504 identifies the operation time of the operation log whose content of operation has been determined to match the start operation in step S1606, as the operation start date and time. In step S1609, the log association processing unit 504 acquires the operation logs illustrated in FIG. 8, which have been collected by the operation log collection unit 503.

In step S1610, the log association processing unit 504 determines whether the content of the operation of the operation log acquired in step S1609 matches the end operations 903 or 904 of the start/end operation information acquired in step S1605. If it is determined that the content of the operation of the operation log acquired in step S1609 matches the end operations 903 or 904 of the start/end operation information acquired in step S1605 (YES in step S1610), then the processing advances to step S1617.

On the other hand, if it is determined that the content of the operation of the operation log acquired in step S1609 does not match the end operations 903 or 904 of the start/end operation information acquired in step S1605 (NO in step S1610), then the processing advances to step S1611.

In step S1611, the log association processing unit 504 determines whether the difference between the operation time of the operation log acquired in step S1609 and the operation time of a subsequent operation log is equal to or greater than a predetermined time.

In the present exemplary embodiment, if it is determined that the user has not executed any operation for the time period equivalent to the predetermined time, then the log association processing unit 504 determines that the image forming apparatus has not been used. In the present exemplary embodiment, the predetermined time is previously set. The log association processing unit 504 (FIG. 5) can update and hold a value of the predetermined time. In the present exemplary embodiment, the predetermined time of sixty seconds is set as described above.

If it is determined that the difference between the operation time of the operation log acquired in step S1609 and the operation time of a subsequent operation log is equal to or greater than the predetermined time (YES in step S1611), then the processing advances to step S1617. On the other hand, if it is determined that the difference between the operation time of the operation log acquired in step S1609 and the operation time of a subsequent operation log is smaller than the predetermined time (NO in step S1611), then the processing advances to step S1612.

In step S1612, the log association processing unit 504 acquires the operation start/end information from the operation start/end information table illustrated in FIG. 9.

In step S1613, the log association processing unit 504 determines whether the content of the operation of the operation log acquired in step S1609 matches the start operation 902 of the start/end operation information acquired in step S1612. If it is determined that the content of the operation of the operation log acquired in step S1609 matches the start operation 902 of the start/end operation information acquired in step S1612 (YES in step S1613), then the processing advances to step S1615.

On the other hand, if it is determined that the content of the operation of the operation log acquired in step S1609 does not match the start operation 902 of the start/end operation information acquired in step S1612 (NO in step S1613), then the processing advances to step S1614.

In step S1614, the log association processing unit 504 determines whether information about all the operation job types stored in the start/end operation information table has been acquired.

If it is determined that information about all the operation job types stored in the start/end operation information table has been acquired (YES in step S1614), then the processing returns to step S1609 and executes the processing in step S1609 and beyond again.

On the other hand, if it is determined that information about all the operation job types stored in the start/end operation information table has not been acquired (NO in step S1614), then the processing returns to step S1612 and executes the processing in step S1612 and beyond again.

In step S1615, the log association processing unit 504 identifies the operation time of the operation log whose content of operation has been determined to match the start operation in step S1613, as the operation end date and time.

In step S1616, the log association processing unit 504 outputs information, such as the operator 1002, the job type 1003, the operation start date and time 1004, the operation end date and time 1005, and the related operation log ID 1006, to the operation log association information table illustrated in FIG. 10. Then, the processing returns to step S1608.

In the present exemplary embodiment, the operation start date and time 1004 is the operation start date and time set in step S1608. The operation end date and time 1005 is the operation end date and time set in step S1615. The job type 1003 is the “job type to be associated with job log” 905 of the start/end operation information acquired in step S1605 or S1612.

The operator 1002 and the related operation log ID 1006 respectively correspond to the operator 703 and the operation log ID 701 of the operation log collected during a time period from the timing of the processing in step S1608, in which the log association processing unit 504 sets the operation time of an operation log as the operation start date and time, to the timing of the processing in step S1613, in which it is determined that the content of the operation matches the start operation.

In step S1617, the log association processing unit 504 records the operation time of the operation log whose content of operation has been determined to match the end operation in step S1610, in the table as the operation end date and time.

In step S1618, the log association processing unit 504 outputs the operator 1002, the job type 1003, the operation start date and time 1004, the operation end date and time 1005, and the related operation log ID 1006 to the operation log association information table illustrated in FIG. 10.

In the present exemplary embodiment, the operation start date and time 1004 is the operation start date and time set in step S1608. The operation end date and time 1005 is the operation end date and time set in step S1615. The job type 1003 is the “job type to be associated with job log” 905 of the start/end operation information acquired in step S1605 or S1612.

The operator 1002 and the related operation log ID 1006 respectively correspond to the operator 703 and the operation log ID 701 of the operation log collected during a time period from the timing of the processing in step S1608, in which the log association processing unit 504 sets the operation time of an operation log as the operation start date and time, to the timing of the processing in step S1610, in which it is determined that the content of the operation matches the start operation.

In step S1619, the log association processing unit 504 determines whether to associate the operation log association information output in step S1618 with the job log. More specifically, the log association processing unit 504 determines that the operation log association information output in step S1618 is to be associated with the job log only if it is determined that the “description of operation” field 704 of the operation log matches the end operation 903 in step S1610.

If it is determined that the operation log association information output in step S1618 is not to be associated with the job log (NO in step S1619), then the processing advances to step S1621. On the other hand, if it is determined in that the operation log association information output in step S1618 is to be associated with the job log (YES in step S1619), then the processing advances to step S1620.

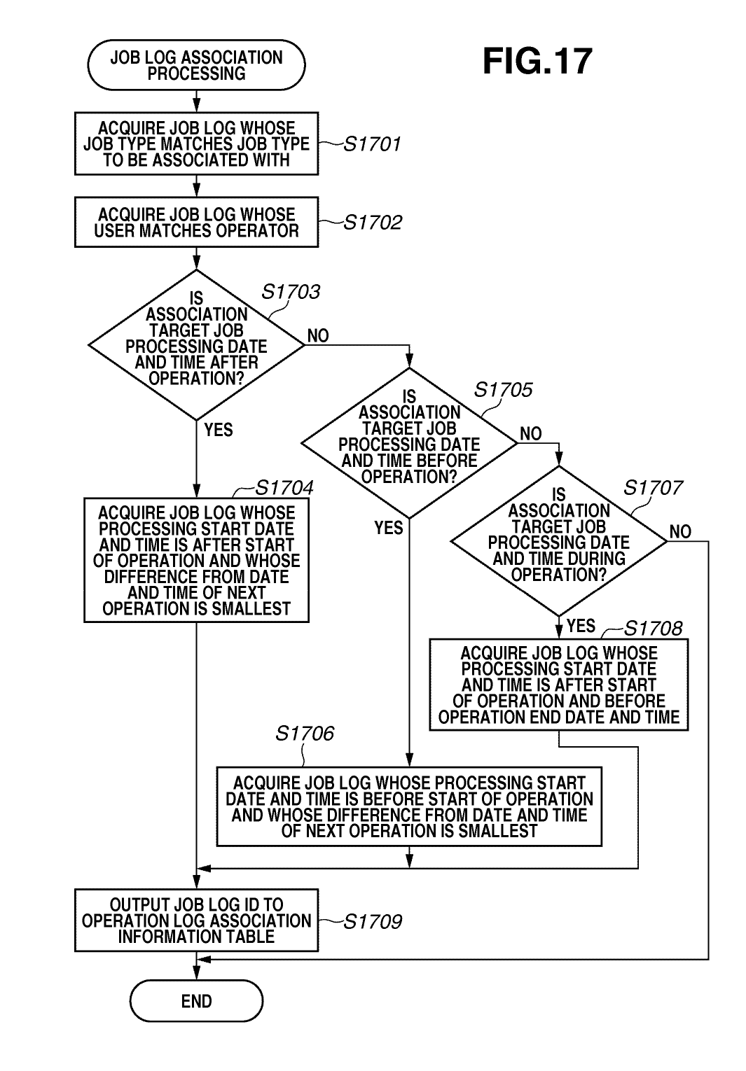

In step S1620, the log association processing unit 504 executes processing for associating the operation log association information with the job log. The job log association processing executed by the log association processing unit 504 will be described in detail below with reference to a flow chart of FIG. 17.

In step S1621, the log association processing unit 504 determines whether the log association processing has been completely executed on all the operation logs collected in step S1602.

If it is determined that the log association processing has not been completely executed on all the operation logs collected in step S1602 yet (NO in step S1621), then the processing returns to step S1605 and executes the processing in step S1605 and beyond again. On the other hand, if it is determined that the log association processing has been completely executed on all the operation logs collected in step S1602 (YES in step S1621), then the processing ends.

FIG. 17 is a flow chart illustrating an example of second data processing executed by the management apparatus according to an exemplary embodiment of the present invention.

In the example illustrated in FIG. 17, the present exemplary embodiment executes the job log association processing, which is executed in step S1620 (FIG. 16). Each step of the processing in the flow chart of FIG. 17 is implemented by the CPU 201 of the log collection server 102 by loading and executing a control program from the HD 211 or the ROM 202 on the RAM 203.

Referring to FIG. 17, when job log association processing has started, in step S1701, the log association processing unit 504 acquires job logs of the job type to be associated with of the operation start/end information from the job log collection unit 502.

In step S1702, the log association processing unit 504 searches the job logs collected in step S1701 to acquire the job log of the user who matches the operator. In step S1703, the log association processing unit 504 determines whether the processing time of the job to be associated with the job log of the start/end operation information is “after operation” by referring to the “job to be associated with job log” field 906 (FIG. 9).

If it is determined that the processing time of the job to be associated with the job log of the start/end operation information is not “after operation” (NO in step S1703), then the processing advances to step S1705.

On the other hand, if it is determined that the processing time of the job to be associated with the job log of the start/end operation information is “after operation” (YES in step S1703), then the processing advances to step S1704.

In step S1704, the log association processing unit 504 searches the job logs collected in step S1702 to acquire a job log having a processing start date and time later than the operation start date and time and whose difference from the operation start date and time is the smallest.

In step S1705, the log association processing unit 504 determines whether the processing time of the job to be associated, of the start/end operation information, is “before operation”.

If it is determined that the processing time of the job to be associated with the job log of the start/end operation information is not “before operation” (NO in step S1705), then the processing advances to step S1707. On the other hand, if it is determined that the processing time of the job to be associated with the job log of the start/end operation information is “before operation” (YES in step S1705), then the processing advances to step S1706.

In step S1706, the log association processing unit 504 searches the job logs collected in step S1702 to acquire a job log having a processing start date and time earlier than the operation start date and time and whose difference from the operation start date and time is the smallest. Then, the processing advances to step S1709.

In step S1707, the log association processing unit 504 determines whether the processing time of the job to be associated with the job log of the start/end operation information is “during operation”.

If it is determined that the processing time of the job to be associated with the job log of the start/end operation information is not “during operation” (NO in step S1707), then the processing ends. On the other hand, if it is determined that the processing time of the job to be associated with the job log of the start/end operation information is “during operation” (YES in step S1707), then the processing advances to step S1708.

In step S1708, the log association processing unit 504 searches the job logs collected in step S1702 to acquire a job log having a processing start date and time later than the operation start date and time and before the operation end date and time. Then, the processing advances to step S1709.

In step S1709, the log association processing unit 504 sets the job log ID of the job log collected from step S1704, S1706, or S1708 as the related operation log ID. In addition, the log association processing unit 504 outputs the same to the operation log association information table illustrated in FIG. 10. Then, the processing ends. By executing the above-described processing, the present exemplary embodiment can manage the mutually-associated operation logs and job.

In addition, by referring to the related job log 1007, the log collection server 102 can execute analysis and thereby recognize that the user has pressed the cancel button during an operation to execute another operation.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-003626 filed Jan. 9, 2009, which is hereby incorporated by reference herein in its entirety.

What is claimed is:

1. A management apparatus configured to collect operation log information and job log information from an image forming apparatus, the management apparatus comprising:
an identification unit configured to identify a plurality of operation logs corresponding to a series of operations executed on a job requested by a user and included in the operation log information collected from the image forming apparatus; and
an association unit configured to associate a job log corresponding to the job requested by the user and included in the job log information collected from the image forming apparatus with the plurality of operation logs identified by the identification unit,
wherein the operation log included in the operation log information includes information about an operation time when the operation is performed,
wherein the job log included in the job log information includes information about processing time of the job,
wherein the identification unit is configured to identify a start operation log corresponding to an operation for starting the series of operations, and
wherein the association unit is configured to associate the job log whose processing time is earlier than an operation time of the start operation log with the plurality of operation logs identified by the identification unit, according to a content of the series of operations.

2. The management apparatus according to claim 1, wherein the association unit is configured, if the content of the series of operations is job verification processing, to associate the job log whose processing time is earlier than the operation time of the start operation log with the plurality of operation logs identified by the identification unit.

3. The management apparatus according to claim 1, wherein the operation log included in the operation log information further includes operation information input by the user.

4. The management apparatus according to claim 3, wherein the identification unit is configured to identify a start operation log corresponding to the start operation of the series of operations and an end operation log corresponding to an end operation of the series of operations according to the operation information of the operation log.

5. The management apparatus according to claim 4, wherein the identification unit is configured to identify the start operation log, an operation log between the start operation log and the end operation log, and the end operation log as a plurality of operation logs corresponding to the series of operations in chronological order of the operation time of the operation log of the same image forming apparatus.

6. The management apparatus according to claim 4, wherein the identification unit is configured, if no end operation log exists within two start operation logs, to identify operation logs between a first start operation log and a start operation log as the plurality of operation logs corresponding to the series of operations in chronological order of the operation time of the operation log of the same image forming apparatus.

7. The management apparatus according to claim 1, wherein the operation log and the job log further include user information.

8. A management apparatus configured to collect operation log information and job log information from an image forming apparatus, the management apparatus comprising:
an identification unit configured to identify a plurality of operation logs corresponding to a series of operations executed on a job requested by a user and included in the operation log information collected from the image forming apparatus; and
an association unit configured to associate a job log corresponding to the job requested by the user and included in the job log information collected from the image forming apparatus with the plurality of operation logs identified by the identification unit,
wherein the association unit is configured to associate a plurality of job logs corresponding to a job requested by the user with the plurality of operation logs identified by the identification unit according to a type of the job requested by the user or a content of the series of operations.

9. The management apparatus according to claim 8, wherein the association unit is configured, if the type of the job requested by the user is a job to be processed by a plurality of image forming apparatuses operating in cooperation with one another or if the content of the series of operations is maintenance processing, to associate the plurality of job logs corresponding to the job with the plurality of operation logs identified by the identification unit.

10. The management apparatus according to claim 8, wherein the operation log included in the operation log information further includes operation information input by the user and information about an operation time of the operation.

11. The management apparatus according to claim 10, wherein the identification unit is configured to identify a start operation log corresponding to the start operation of the series of operations and an end operation log corresponding to an end operation of the series of operations according to the operation information of the operation log.

12. The management apparatus according to claim 11, wherein the identification unit is configured to identify the start operation log, an operation log between the start operation log and the end operation log, and the end operation log as a plurality of operation logs corresponding to the series of operations in chronological order of the operation time of the operation log of the same image forming apparatus.

13. The management apparatus according to claim 11, wherein the identification unit is configured, if no end operation log exists within two start operation logs, to identify operation logs between a first start operation log and a second start operation log as the plurality of operation logs corresponding to the series of operations in chronological order of the operation time of the operation log of the same image forming apparatus.

14. A method in a management apparatus configured to collect operation log information and job log information from an image forming apparatus, the method comprising:
identifying a plurality of operation logs corresponding to a series of operations executed on a job requested by a user and included in the operation log information collected from the image forming apparatus; and
associating a job log corresponding to the job requested by the user and included in the job log information collected from the image forming apparatus with the plurality of identified operation logs,
wherein the operation log included in the operation log information includes information about an operation time when the operation is performed, and
wherein the job log included in the job log information includes information about processing time of the job,
identifying a start operation log corresponding to an operation for starting the series of operations, and
associating the job log whose processing time is earlier than an operation time of the start operation log with the plurality of identified operation logs, according to a content of the series of operations.

15. The method according to claim 14, further comprising associating, if the content of the series of operations is job verification processing, the job log whose processing time is earlier than the operation time of the start operation log with the plurality of identified operation logs.

16. A method in a management apparatus configured to collect operation log information and job log information from an image forming apparatus, the method comprising:
identifying a plurality of operation logs corresponding to a series of operations executed on a job requested by a user and included in the operation log information collected from the image forming apparatus; and
associating a job log corresponding to the job requested by the user and included in the job log information collected from the image forming apparatus with the plurality of identified operation logs; and
associating a plurality of job logs corresponding to a job requested by the user with the plurality of identified operation logs according to a type of the job requested by the user or a content of the series of operations.

17. The method according to claim 16, further comprising associating, if the type of the job requested by the user is a job to be processed by a plurality of image forming apparatuses operating in cooperation with one another or if the content of the series of operations is maintenance processing, the plurality of job logs corresponding to the job with the plurality of identified operation logs.

18. A computer-readable storage medium storing a computer program for causing a computer to execute a method for collecting operation log information and job log information from an image forming apparatus, the method comprising:
identifying a plurality of operation logs corresponding to a series of operations executed on a job requested by a user and included in the operation log information collected from the image forming apparatus; and
associating a job log corresponding to the job requested by the user and included in the job log information collected from the image forming apparatus with the plurality of identified operation logs,
wherein the operation log included in the operation log information includes information about an operation time when the operation is performed, and
wherein the job log included in the job log information includes information about processing time of the job,
identifying a start operation log corresponding to an operation for starting the series of operations, and
associating the job log whose processing time is earlier than an operation time of the start operation log with the plurality of identified operation logs, according to a content of the series of operations.

19. A computer-readable storage medium storing a computer program for causing a computer to execute a method for collecting operation log information and job log information from an image forming apparatus, the method comprising:
identifying a plurality of operation logs corresponding to a series of operations executed on a job requested by a user and included in the operation log information collected from the image forming apparatus; and
associating a job log corresponding to the job requested by the user and included in the job log information collected from the image forming apparatus with the plurality of identified operation logs; and
associating a plurality of job logs corresponding to a job requested by the user with the plurality of identified operation logs according to a type of the job requested by the user or a content of the series of operations.
